(19) United States
(12) Patent Application Publication
(10) Pub. No.: US 2017/0270546 A1
(43) Pub. Date: Sep. 21, 2017

(54) SERVICE CHURN MODEL

(71) Applicant: Tata Motors Limited, Mumbai (IN)

(72) Inventors: Vikram Madhav KULKARNI, Mumbai (IN); Amitabh JHA, New Delhi (IN)

(21) Appl. No.: 15/464,376

(22) Filed: Mar. 21, 2017

(30) Foreign Application Priority Data
Mar. 21, 2016 (IN) 201621007917

(51) Int. Cl. G06Q 30/02; G06N 5/04

(52) U.S. Cl. CPC G06Q 30/0202; G06N 5/04; G06Q 30/0201

(57) ABSTRACT

A predictive model is disclosed for vehicle service analysis, where after-sales actionable variables are identified, that are important to customer satisfaction and impact customer retention, which are applied to the model. The model provides recommendations for customer retention.

### CROSS-REFERENCES TO RELATED APPLICATIONS

This application is related to and claims priority from commonly owned India Patent Application No. 201621007917, entitled: Service Churn Model, filed on Mar. 21, 2016, the disclosure of which is incorporated by reference in its entirety herein.

### FIELD OF THE INVENTION

The present invention relates to commercial vehicle service analysis and customer retention.

### REFERENCE TO LARGE TABLE APPENDIX

This specification is accompanied by a Large Table Appendix, provided in the attached file in ASCII characters. This attached file is submitted herewith as Appendix LT, in duplicate. Appendix LT includes an electronic file entitled Table 1.txt, created Mar. 21, 2017, which is 26 MB. Appendix LT is incorporated by reference herein, as though fully replicated herein.

### BACKGROUND OF THE INVENTION

Automobile dealerships typically include service departments and serve as original and official, e.g., factory authorized, points of service, collectively referred to as “officially authorized” points of service. These officially authorized points of service presently face increasing competition from the unofficial points of service, and service networks, which are commonly local garages and other captive workshops (owned by the commercial vehicle fleet owners), and not “officially authorized” points of service, as they are not authorized by the automobile manufacturer. As a result of the rapid growth of these unofficial or “unauthorized” points of service, officially authorized points of service have found it increasingly difficult to retain their present customers.

The greatest reason for the rise in defections to the unofficial points of service is that there are cost variations for services, which are offered by local garages/workshops and company service centers. To counter these services from unofficial points of service, most automobile manufacturers, via the officially authorized points of service, typically new car dealers, offer certain numbers of free services to customers, as incentives for these customers to return to their officially authorized points of service. However, it has been found that this only provides a temporary solution, as most customers do not return to the official authorized points of service after the free services have ended.

Additionally, most organizations do not have any strategies for retaining customers of the vehicles that come for services to their service centers. Vehicles are typically serviced without any differentiation of key variables, such as repair time, discounting, and the like. Also, the workshop manager does not have any direction to identify the vehicles that have a high probability to churn. “Churn” is the chassis (vehicle) attrition, and is the number of chassis (vehicles), via their owners, e.g., customers, that discontinue service (for example, from “officially authorized” points of service) during a specified time period. Accordingly, customer defections from officially authorized service points to unofficial points of service, continue to cause lost revenues for automobile companies and/or officially authorized points of service.

### SUMMARY OF THE INVENTION

The present invention relates to field of commercial vehicle service analysis where after-sales actionable variables are identified, that are important to customer satisfaction and impact customer retention, which result in recommendations for customer retention.

The present invention provides mechanisms to ensure that the post-sales customer base of the automobile company continues to seek service at officially authorized points of service. In other words, the invention provides mechanisms to keep vehicles in a network, the network defined by official sellers or dealers of the vehicles and authorized service enters for the vehicles. This way, the customer base does not erode, such that servicing, which would have been provided by officially authorized points of service, is now performed at local unofficial garages/workshops, which are not part of the automobile company's servicing and officially authorized points of service network.

Some embodiments of the present invention provide for a method for after-sales retention of customers. These embodiments typically include at least the following two processes:
1. Post implementation. This process requires checking the adherence of the channel partners, to make sure they take the suggested actions for high probability churn customers; and,
2. Analyzing decay tracking to obtain the future churn probability of the customers, for whom actions have been extended in previous service visits.

Embodiments of the present invention provide systems and methods for identifying vehicles (e.g., vehicle owners and operators), which are not likely to return to the official authorized points of service (go out of the network), and prepare churn prevention strategies for them. The invention includes applying data cleaning techniques (like missing values imputation) on raw data pulled from the data warehouses for the application, which use advanced analytics. By using advanced econometric methodologies, the disclosed methods and systems build a predictive model, so that every vehicle's churn probability (e.g., the probability of the vehicle leaving the network, such as for servicing) is calculated. With each churn probability calculated, strategies are created for each automobile manufacturer, seller or official authentic point of service (all within a network), to prevent churn. The invention analyzes the various collected data fields, so the data fields capture the strategies and prepare it to be used for segmentation.

The invention creates strategic interventions, and identifies certain strategic interventions which are statistically significant, and uses these strategic interventions to create segments. The segments are derived on the basis of statistical techniques, whose fundamentals lie in Bonferonni probabilities for identifying which strategies are required for which vehicle to prevent its churn. The manufacturer then takes down these statistically derived recommendations, and transforms/interprets them to the strategies to be understood by the team on the ground (e.g., at the officially authorized point of service). This process prepares a data chain, which is completed, starting from the data and going up to on-ground implementation.

Thus, the present invention solves the problem of declines in after-sales customer retention, The organization is also facing static or reducing market share in commercial vehicle sales, primarily due to entry of new competitors. This invention provides methods and systems for compensating in the drop in sales revenue, by increasing sales opportunities through better after-sales service experience of current customers.

Embodiments of the invention are directed to a method for determining the probability of a vehicle remaining in a network comprising authorized dealers and authorized points of service. The method comprises: building a predictive model, using a processor, to determine the probability that the vehicle remains in the network. The building of the predictive model includes: obtaining vehicle sales data, vehicle service transactions, and a churn value; and, creating variables for the predictive model from the obtained vehicle sales data, vehicle service transactions, and a churn value. Variables are inputted into the model for a vehicle, to determine the probability of the vehicle remaining in the network.

Optionally, the churn value includes a probability that a vehicle will not return to a network point of service after the instant service, for its next service.

Optionally, the method additionally comprises: prior to inputting variables for a vehicle, testing the predictive model.

Optionally, the testing the predictive model includes applying a missing value treatment to the predictive model.

Optionally, the testing the predictive model additionally includes performing a multicolinearity check.

Optionally, the testing the predictive model additionally includes applying logistic regression to a set of variables input into the predictive model for significance.

Optionally, the testing the predictive model additionally includes validating the predictive model.

Embodiments of the invention are directed to a computer usable non-transitory storage medium having a computer program embodied thereon for causing a suitable programmed system to determining the probability of a vehicle remaining in a network comprising authorized dealers and authorized points of service, by performing the following steps when such program is executed on the system. The steps comprise: building a predictive model to determine the probability that the vehicle remains in the network, including: obtaining vehicle sales data, vehicle service transactions, and a churn value; and, creating variables for the predictive model from the obtained vehicle sales data, vehicle service transactions, and a churn value. Variables are inputted into the model for a vehicle, to determine the probability of the vehicle remaining in the network.

Optionally, for the computer usable non-transitory storage medium, the churn value includes a probability that a vehicle will not return to a network point of service after the instant service, for its next service.

Optionally, for the computer usable non-transitory storage medium additionally comprises: prior to inputting variables for a vehicle, testing the predictive model.

Optionally, for the computer usable non-transitory storage medium, the testing the predictive model includes applying a missing value treatment to the predictive model.

Optionally, for the computer usable non-transitory storage medium, the testing the predictive model additionally includes performing a multicolinearity check.

Optionally, for the computer usable non-transitory storage medium, the testing the predictive model additionally includes applying logistic regression to a set of variables input into the predictive model for significance.

Optionally, for the computer usable non-transitory storage medium, the testing the predictive model additionally includes validating the predictive model.

Embodiments of the invention are also directed to a method for determining the probability of a vehicle remaining in a network, the network comprising authorized entities. The method comprises: building a predictive model, using a processor, to determine the probability that the vehicle remains in the network; creating variables for the predictive model from data comprising one or more of: obtained vehicle sales data, vehicle service transactions, and a churn value; obtaining the churn probability for the vehicle with respect to an authorized entity; and, inputting variables and the churn probability into the predictive model for a vehicle to determine the probability of the vehicle remaining in the network.

Optionally, the method is such that obtaining the churn probability for the vehicle with respect to an authorized entity includes building a regression model, using a processor, and determining the churn probability from the regression model.

Optionally, the method is such that the determining the churn probability from the regression model includes scoring the vehicle by using an equation:

Pᵢ=αᵢ+βXᵢ

where, Pᵢ is the churn probability, α is the intercept term in the equation, β is the coefficient of the predictor variable Xᵢ.

Optionally, the method is such that the authorized entities include at least one of dealers and authorized points of service.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings and in this document, the terms “Figure” or “Figures”, are interchangeable with “FIG.” and “FIGs.” respectively, and “Fig,” and “Figs.” Respectively, In the drawings:

FIGS. 1a and 1b show flow diagrams for implementation of a service churn model;

FIG. 2 illustrates process flow of service churn model creation;

FIG. 3 illustrates process flow of variable creations;

FIG. 4 shows the flow chart for process flow of logistic regression predictive model building;

FIG. 5a shows Lift Curve during logistic model building showing a lift of 31.3%;

FIG. 5b shows Lift Curve during Out of time testing stage shows a lift of 31.7%;

FIG. 6 shows a flow diagram for implementation of complete process of service churn model; and,

FIG. 7 illustrates flow diagram showing flow of data from dealers to final output.

Tables 1-9c are provided in the order listed in the description below.

Appendix A is provided at the end of the Detailed Description.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the limn of a computer program product embodied in one or more non-transitory computer readable (storage) medium(s) having computer readable program code embodied thereon.

The present invention is directed to methods and systems for determining the probability of a vehicle remaining in a network, the network comprising authorized dealers and authorized points of service. The method and system provide for elements, including, for example, an initial step of building a predictive model, using a processor, to determine the probability that the vehicle remains in the network. This is followed by creating variables for the predictive model from the obtained vehicle sales data, vehicle service transactions, and a churn value. The next process includes obtaining the churn probability of the chassis (vehicle) using analytical engines, such as an SAS® Analytical Engine (SAS Institute Inc. of Cary, N.C., USA), housed in or otherwise associated with a server of the system, using a computer and data processing tool and a regression model, which was built for this application. Next, a process known as “scoring a chassis (vehicle)” is done through using an equation:

Pᵢ=αᵢ+βXᵢ

where, Pᵢ is the churn probability, α is the intercept term in the equation, β is the coefficient of the predictor variable Xᵢ.
Finally, variables are input into the model for a vehicle to determine the probability of the vehicle remaining in the network.

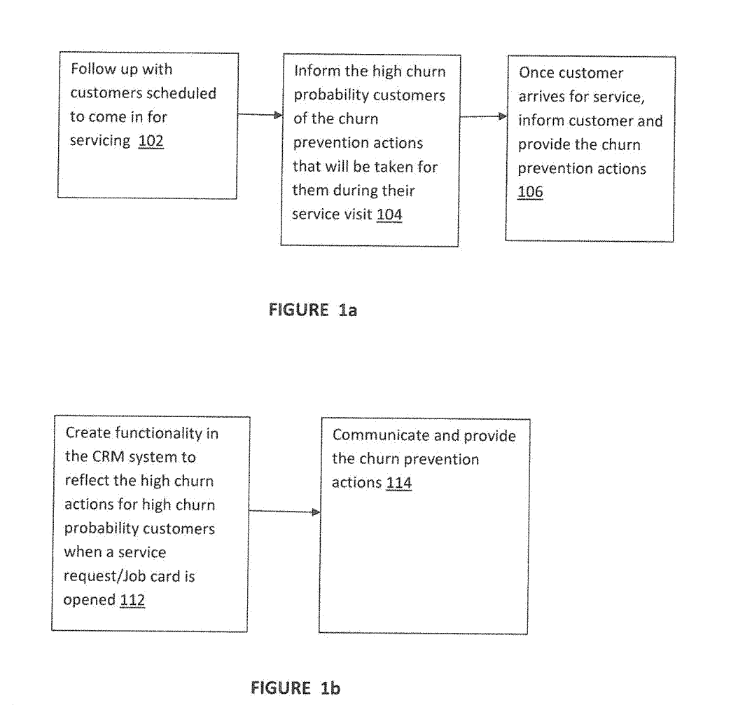

FIGS. 1a and 1b show an exemplary process with two implementations. The first implementation, shown in FIG. 1a, includes a process, where at block 102, a follow-up is performed with customers scheduled to come to the officially authorized point of service, for their vehicle to be serviced. At block 104, customers with a high churn probability are informed of churn prevention actions that will be taken for them. At block 106, the customer, upon arrival, is provided with the churn prevention actions.

The second implementation, as shown in FIG. 1b, begins at block 112, where in the (Customer Relationship Management (CRM) system, functionality is created to reflect the churn actions for high churn probability customers, when a service request/job card, is opened for that customer. The process then moves to block 114, where the churn prevention action in the CRM system is communicated and provided to the customer.

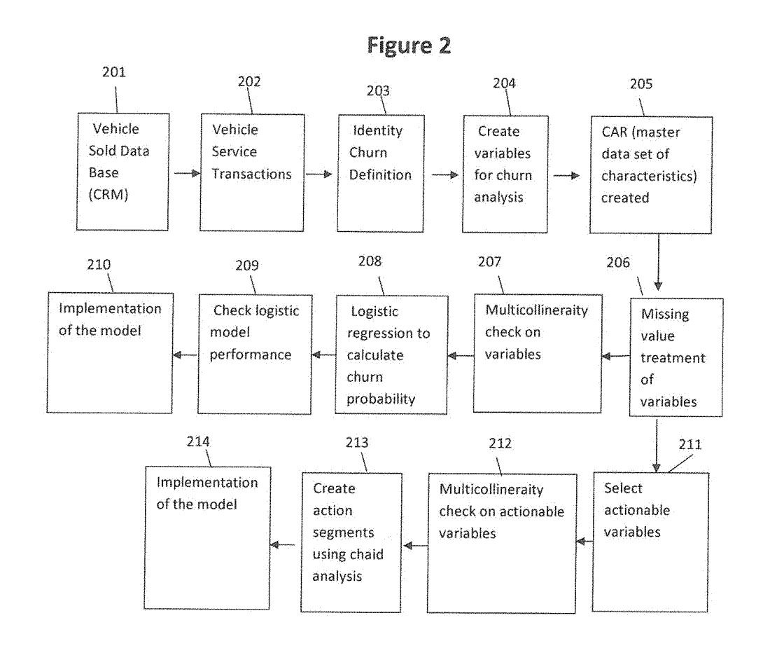

FIG. 2 is a flow diagram showing an overall process for creating a service churn model. The process begins at block 201, where vehicle sold data is entered into the system, in particular, into the CRM software. Vehicle service transactions are entered into the system, in particular, into the CRM software, at block 202. The churn for the model is then defined, at block 203. Variables are then created for the churn analysis, at block 204. At block 205, master data for a set of characteristics is created. The process moves to block 206, where missing value treatment is applied to the model.

From block 206, the process moves to block 207, where there is a multicolinearity check on values for the model. The process moves to block 208, where a logistic regression is performed. The logistic model performance is checked at block 209, and the logic model is implemented at block 210.

Returning to block 206, the process moves to block 211, where actionable variables are selected. The process then moves to block 212 where there is a multicolinearity Check on the actionable values for the model. The process moves to block 213, where action segments are created for a decision tree model. The process moves to block 214, where the action segments are implemented.

These processes of blocks 201-214 are now explained in greater detail.

### Block 201—Vehicle Sold Database (CRM):

Sales information of vehicles is captured in CRM (Customer Relationship Management) software, where information is provided through details captured by dealer sales expertise after the sale of a vehicle is closed. From here various tables with different sales attributes are extracted.

A list of the sales information tables used for building a service churn model is provided in Table 1.

### Block 202—Vehicle Service Transactions:

When a chassis (vehicle) comes for service at any officially authorized point of service, various parameters related to service, like job card created date, service type, and the like, are stored in CRM system. From here, various service related fields in multiple tables are extracted.

A list of the service information tables used for building the service churn model is provided in Table 2.

### Block 203—Churn Definition:

“Churn”, as used herein in this document, is defined as chassis (vehicle) attrition, and is the number of chassis (vehicles) that discontinue service (for example, from “officially authorized” points of service) during a specified time period. The definition followed during the churn model building exercise is presented in Table 3.

### Block 204—Variables Creation:

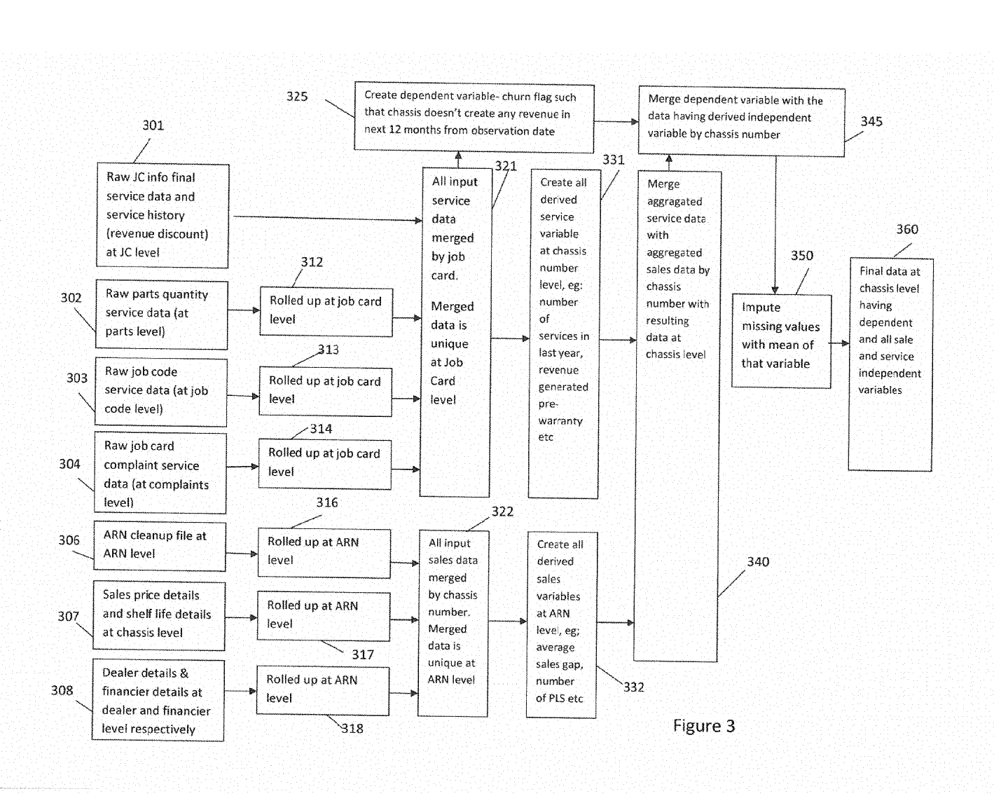

FIG. 3 illustrates the process flow of the service churn model, as it is created, in detail. The data preparation process follows the following steps, in each predetermined time period, for example, each month. The process is as follows.

a. Receive sales and service files (mentioned for Block 201 and Block 202 above) for 25 months history of the chassis which came for service in “May '13”. This includes obtaining raw Job Card (JC) information and service history information, at block 301, raw parts quality service data, at block 302, raw job code service data, at block 303, and raw job card compliant service data, at block 304.

b. Receive the Account Relationship Number (ARN) file (this is up to date with all historical sales records to date), such as the ARN cleanup file (at the ARN level), at block 306, sales price details and shelf life details at the chassis level, at block 307, and dealer details and financier details at the dealer and financier levels, at block 308.

c. Convert the CSV (Comma Selected Values in Microsoft® Excel format) files to SAS® datasets (SAS® from SAS Institute of Cary, N.C., USA) for further processing, at blocks 312, 313 and 314.

d. Bring all sales files (ARN data, Dealer wise details, Sales price details, Financier details, Shelf life details) at ARN level, and merge them to create sales master data with all the sales information at account level, at blocks 316, 317 and 318.

e. (1) Bring all service files (job card information, Job code details, Part quantity, Service history, Job card complaint) at Job card level, and merge them to create service master data with all the service information at Job card level, at block 321 (from blocks 301 and 312-314). (2) Merge all input data by the chassis (vehicle) number (this merged data is unique at the ARN level), at block 322 (from blocks 316-318).

f. (1) Create derived variables (for example, for services in last three months, average sales gap, turnaround time, etc.) based upon basic variables (for example, sale date, job card created date, job card closed date, etc.) from CRM, at block 331 (from block 321). (2) Create derived sales variables at the ARN level, for example, average sales gap, at block 332 (from block 322).

g. Aggregated service data is merged with aggregated sales data by chassis number, with the resulting data at the chassis level, at block 340 (from blocks 331 and 332).

h. Create a dependent variable, a churn flag based on a chassis (vehicle) not producing any revenue within 12 months from the last observation date, illustrated by the process moving from block 321 to block 325.

i. Merge dependent variables with the data having derived independent variables by chassis number, at block 345 (from blocks 325 and 340).

j. Impute missing values while calculating derived variables, at block 350.

k. Merge the sales and service data created to get consolidated sales and service data at Chassis level, at block 360, from block 350.

### Block 205. CAR (Customer Analytical Record):

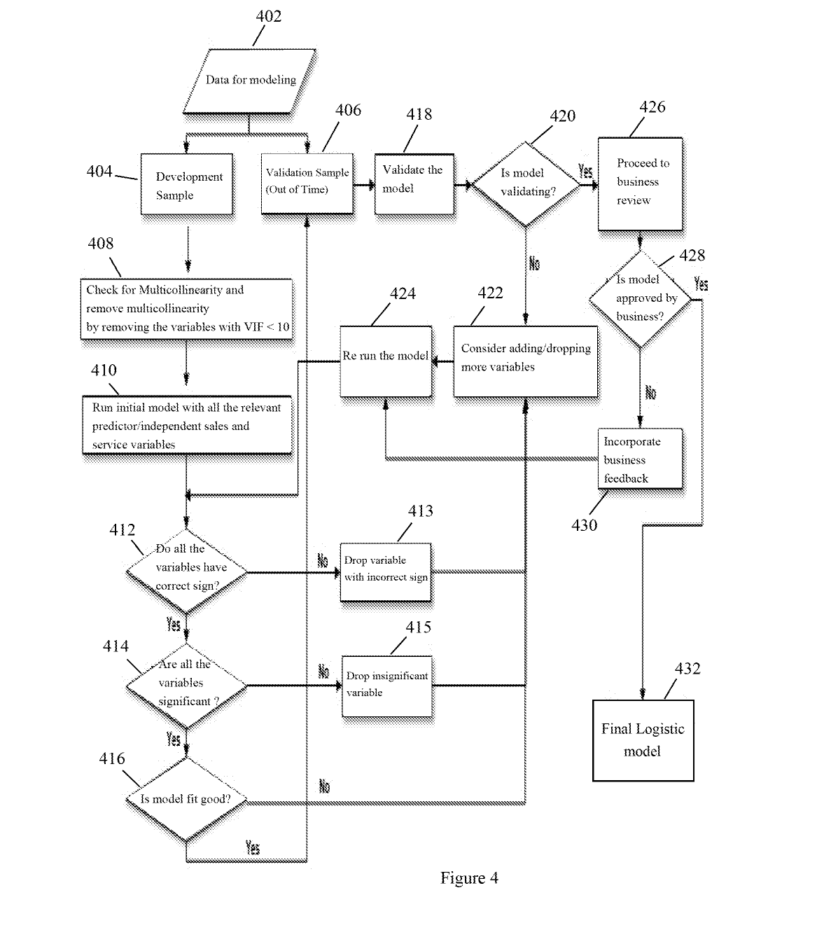

At the completion of the process of FIG. 4, there is a plurality of variables (i.e., 229 Variables), which describe sales and service attributes of the consumer. These 229 variables are, for example, used to explain churn probability of a chassis (vehicle) and are listed in Appendix A, which is attached hereto. In Appendix A, there are the following terms: LPT—Long Platform Truck; MCV—Medium Commercial Vehicle; SE MCV—Semi Forward Medium Commercial Vehicle; TM—Tata Motors; and, MOB—Months on Book.

### Block 206. Missing Value Treatment:

Missing data cannot be present in the input of logistic regression. Missing value treatment is required for any data with missing values prior to logistic model building. Missing values can be replaced in many ways which, for example, includes mean replacement, median replacement, mode replacement, regression method, etc. For analysis purposes, wherever required, mean replacement of missing values are used.

### Block 207. Multicollinearity Check:

Multicollinearity is a phenomenon in which two or more predictor variables in a multiple regression model are highly correlated, meaning that one can be linearly predicted from the others with a non-trivial degree of accuracy.

Multicollinearity can result in several problems. These problems are as follows:
The partial regression coefficient due to multicollinearity may not be estimated precisely. The standard errors are likely to be high.
Multicollinearity results in a change in the signs as well as in the magnitudes of the partial regression coefficients from one sample to another sample.
Multicollinearity makes it tedious to assess the relative importance of the independent variables in explaining the variation caused by the dependent variable.

### Process to Tackle Multicolinearity:

VIF (Variance Inflation Factor) measures how much the variance of the estimated regress ion coefficient is “inflated” by the existence of correlation among the predictor variables in a model, a cutoff of VIF<10 is used to tackle multicolinearity, expressed as:

VIF(βᵢ)=1/(1−R²)

where βᵢ is an elasticity coefficient of the regression model for the i^{th} variable; and, R² is represents the accuracy of the “fit” with the statistical model.

During multicollinearity check where VIF>10, eighty-two variables were dropped in the process. Thus, 147 variables (remaining from the 229 variables of Appendix A) were further considered for binomial logistic regression.

### Block 208. Logistic Regression:

Logistic regression can be binomial or multinomial. Binomial or binary logistic regression deals with situations in which the Observed outcome for a dependent variable can have only two possible types (for example, “win” vs. “loss”). Multinomial logistic regression deals with situations where the outcome can have three or more possible types (e.g., “disease A” vs. “disease B” versus “disease C”). In binary logistic regression, the outcome is usually coded as “0” or “1”.

Logistic regression is used to predict the odds of “1” based on the values of the independent variables (predictors).

Logistic regression makes use of one or more independent variables that may be either continuous or categorical data. Logistic regression is used for predicting binary outcomes of the dependent variable rather than a continuous outcome. Given this difference, it is necessary that logistic regression take the natural logarithm of the odds of the dependent variable being a case (referred to as the logit car log-odds) to create a continuous criterion as a transformed version of the dependent variable. Thus, the logit transformation is referred to as the link function in logistic regression—although the dependent variable in logistic regression is binomial, the logit is the continuous criterion upon which linear regression is conducted.

The logit of success is then fitted to the predictors using linear regression analysis. The predicted value of the logit is converted back into predicted odds via the inverse of the natural logarithm, namely the exponential function.

The logistic function G(t) is defined as follows:

G(t)=e^{t}/(e^{t}+1)=1/(1+e^{-t})

where e^{t} is the exponential.

If “t” is viewed as a linear function of an explanatory variable “x” (or of a linear combination of explanatory variables), then “t” is expressed follows:

t=βo+β₁x

where,
βo is the intercept term in the model implying a fixed effect without any impact of independent variables; and,
β₁x is the impact of the independent variable.

The logistic function F(x) can now be written as:

F(x)=1/(1+e^{-(βo+β1x)})

### 8.1 Logistic Model Development:

FIG. 4 (FIG. 4) illustrates process flow of logistic regression predictive model building. The model building process is an iterative process wherein a set of variables are tried for significance. Any variables that are not significant or show multicollinearity are dropped from the process (this is checked by the p-value of independent variables and the VIF values). As a general rule, variables with VIF<10 are retained to ensure no multicollinearity. The present models use the binary logistic regression procedure in SAS® Enterprise Guide®, from SAS Institute, Inc. of Cary, N.C., USA. Some of the statistics which were evaluated to shortlist best iterations were concordance, best variables based on business understanding as well as key statistics explained in section below.

The process of FIG. 4 begins at block 402, where the data for a model is obtained. From block 402, the process moves to blocks 404 and 406, for example, contemporaneous in time. At block 404, a development sample, such as randomizing the entire dataset and picking up a sample of 80% of observations, is obtained, and at block 406, a validation sample is taken, for example, out of time, implying the validation sample is outside of the modeling time frame.

From block 404, the process moves to block 408, where a check for multicolinearity is made and variables are removed when the VIF<10. The process moves to block 410, where an initial model is run, with all relevant predictors of independent sales and service variables.

The process then moves to block 412, where it is determined whether all of the variables have the correct sign. If no, the process moves to block 413, where the variable with the incorrect sign is dropped, and the process moves to block 422. If yes, the process moves to block 414.

At block 414, it is determined whether all of the variables are significant. If no, the process moves to block 415, where the insignificant variable is dropped. From block 415, the process moves to block 422. If yes, the process moves to block 416.

At block 416, it is determined the accuracy of the model fit, and whether the model fit is good. This is based on, for example, user selected, or predetermined criteria. If the model fit is not good, or otherwise satisfactory, in accordance with the criteria, the process moves to block 422. If the model fit is good at block 416, the process moves to block 406.

Returning to block 406, the process moves to block 418, where the model is validated. Next, the process moves to block 420, where it is determined whether the model is validating. If no at block 420, the process moves to block 422, where the system considers adding or dropping more variables. The processes of blocks 413 and 415 also move to block 422. From block 422, the process moves to block 424, where the model is rerun. From block 424, the process moves to block 412, from where it resumes, as detailed above.

Returning to block 420, should the model be validating, the process moves to block 426. At block 426, the process proceeds to a business review, and moving to block 428, it is determined whether the model is approved by business. Should the model not be approved at block 428, the process moves to block 430, where business feedback is incorporated into the model. The process then moves to block 424, where the model is rerun, and the process resumes from block 424, as detailed above.

Returning to block 428, should the model be approved by business, the process moves to block 432, where a logistic model, in accordance with the invention is finalized. It is at block 432, where the process ends.

The model uses various values and variables as follows.

p value—In statistics, the p-value is a function of the observed sample results that are used for testing a statistical hypothesis. Before the test is performed, a threshold value is chosen, called the significance level of the test. If the p-value is less than or equal to the significance level, it suggests that the observed data is inconsistent with the assumption that the null hypothesis is tree and thus that hypothesis must be rejected.

A p-value of 5% or less is the generally accepted point at which to reject the null hypothesis. With a p-value of 5% (or 0.5) there is only a 5% chance that results would have come up in a random distribution, so there is a 95% probability of being correct that the variable is having some effect, assuming the model is specified correctly.

### Concordance

The discriminative-ability of a logistic regression model is frequently assessed using the concordance statistic (c-statistic), a taintless index denoting the probability that a randomly selected subject who experienced the outcome will have a higher predicted probability of having the outcome occur compared to a randomly selected subject who did not experience the event.

The c-statistic is, for example, calculated by taking all possible pairs of subjects consisting of one subject who experienced the event of interest and one subject who did not experience the event of interest.

The c-statistic is the proportion of such pairs in which the subject who experienced the event had a higher predicted probability of experiencing the event than the subject who did not experience the event. The statistic “c” takes values between 0 and 1, and achieves the value 0.5 on average, if a member of each pair is chosen with equal probability. Thus the greater the value above 0.5, the better (e.g., more accurate) is the model.

### Percent Concordant:

Percentage of pairs where the Observation with the desired outcome (event) has a higher predicted probability than the observation without the outcome (non-event).

### Percent Discordant:

Percentage of pairs where the observation with the desired outcome (event) has a lower predicted probability than the observation without the outcome (non-event).

### Percent Tied:

Percentage of pairs where the observation with the desired outcome (event) has same predicted probability than the observation without the outcome (nonevent).

In general, higher percentages of concordant pairs and lower percentages of discordant and tied pairs indicate a more desirable model.

### C-Statistic

The probability that predicting the outcome is better than chance. This parameter is used to compare the accuracy of the fit of logistic regression models. The C-Statistic is a measure of the discriminatory power of the logistic equation. It varies from 0.5 (the model's predictions are no better than chance) to 1.0 (the model always assigns higher probabilities to correct cases, rather than to incorrect cases). Thus c is the percent of all possible pairs of cases in which the model assigns a higher probability to a correct case than to an incorrect case.

### Receiver Operating Characteristic (ROC) Curve

The discrimination of a logistic regression model can also be described by the area under the receiver operating characteristic (ROC) curve. Each value of the predicted probability of the occurrence of the outcome allows for the determination of a threshold. For each possible threshold, the predicted probabilities are dichotomized into those above and below the threshold. Subjects with a predicted probability below the threshold are classified as low risk, while those above the threshold are classified as high risk. The sensitivity and the specificity of these classifications can be estimated. The ROC curve is the plot of sensitivity versus one minus specificity over all possible thresholds. The area under the ROC curve is equivalent to the c-statistic.

### The Gini

The Gini is a common measure that is often used in Credit Risk evaluations to measure the effectiveness of a scorecard in discriminating between good and had credit risks. There are various ways of interpreting the Gini Graph. One example way of interpreting and defining the Gini is that it is the area between the Lorenze Curve and the bottom left to top right diagonal divided by the area under the bottom left to top right diagonal.

### Capture Rate

The Capture rate is a metric that indicates out of all responders captured in total data (10 deciles), what percentage is captured in the top three deciles. If the churn of chassis (vehicles) is being measured, this metric indicates that out of all the chassis which came in for service in the past 18 months, what percentage of these chassis are captured in the top three deciles of the model.

### KS

The Kolmogorov-Smimoff Statistic (KS) when used to measure the discriminatory power of a score card, looks at how the distribution of the score differs among good and bad chassis (Vehicles). The Kolgomorov Statistic (KS) measures the maximum point of separation between the Cumulative Density Function (CDF) of two distributions.

The KS measure gives the separation power, which a model exhibits, which is between the values of “0” and “1”, or “true” and “false.”

The output of KS Macro during logistic model building is provided in Table 4.

### 8.2 Final Logistic Model:

A Final Binomial Logistic Model is built to calculate the probability of churn of a chassis satisfying the criterion mentioned in the above section has the variables listed in Table 5.

### Block 209. Logistic Model Performance:

In logistic regression, one can attempt to “validate” a model built using one data set by finding a second independent data set and checking how well the second data set outcomes are predicted from the model built using the first data set. Model validation is a process to ensure that the model performs as expected. In this step, the scorecard generated by the model is benchmarked against that of the development sample. The following are the different types of validations.

### Out of Sample Validation

If the model is over fitting on development data and not representing the overall data pattern, then using the model will result in biased scores and wrong decision making.

### Out of Time Validation

Validation of model over time, i.e., using data from different time periods, the stability of the model's scorecard performance can be checked over time.

Validating a new data set improves on the idea of splitting a single data set into two parts, because it allows for checking of the model in a different context. In out of time validation, the two contexts from which the two data sets arose are different. Thus, it can be checked how well the first model predicts observations from the second model. As the model does fit, there is some assurance of generalizing the first model to other contexts.

The following are some model performance metrics that are considered for validation.

### Rank Ordering

The first decile should have the highest numbers of responders captured and the number of responders decreases moving downward on the table. If rank ordering holds for a model, then given a cut-off on the target population, at, for example, the top 3 or 4 deciles, this will ensure that most responders are captured, and increasing the decile will not increase the response rate dramatically.

To ensure rank ordering the individuals are first arranged in descending order of their predicted probability, the population is then divided into 10 groups (deciles) and the percentage of responders in each group is calculated. This is the capture rate of target variable in each decile. In a model, ‘responders’ should get a higher score than ‘nonresponders’. So, if observations are sorted by descending scores, all the ‘responders’ should fall in the top deciles. However, since every model will have its own power in predicting the ‘responsiveness’ of an individual, some of the ‘non-responders’ may score higher than the ‘responders’. For a good and accurate model, the capture rate for the target should be in descending order.

### KS Chart and KS Statistic

Shows the maximum ability of the score to separate a ‘Responder’ from a ‘Non-Responder’.

### KS Chart

Plots the cumulative distribution of target records and non-target records against score.

### KS Statistics

The maximum difference between cumulative percentage of target and cumulative percentage of non-target records.

Table 6 shows ‘responder’ output during out of time validation.

### Capture Rate

This is a metric that indicates that out of all responders captured in total data (10 deciles), what percentage is captured in the top three deciles. If churn of chassis is being measured, the metric tells that out of all the chassis which came for service in last 18 months, what percentage of these chassis are captured in the top three deciles of the model.

### Lift

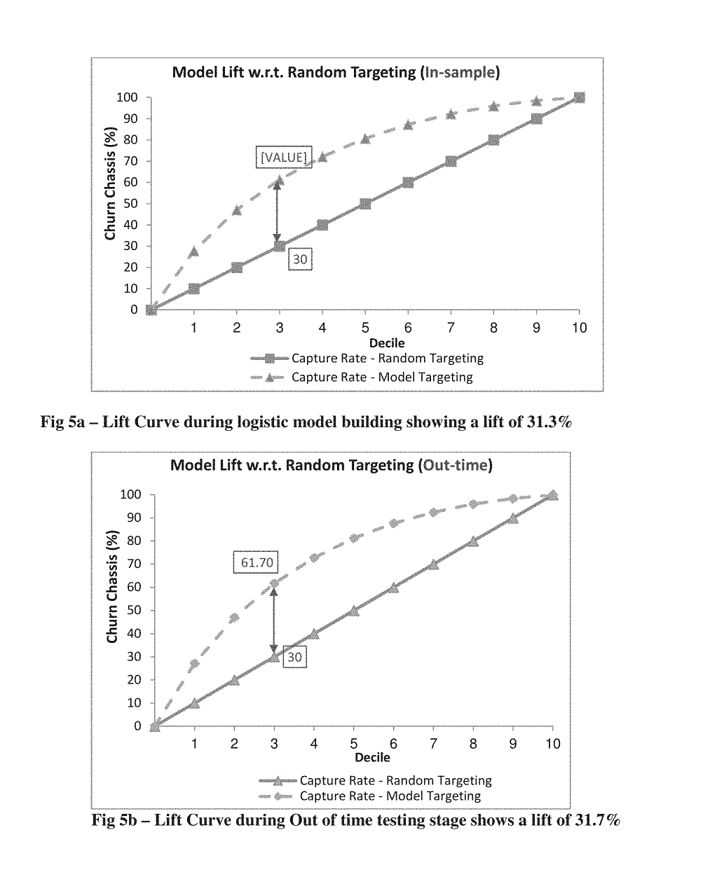

“Lift”, as used herein, is a measure of the effectiveness of a predictive model calculated as the ratio between the results obtained with and without the predictive model. FIGS. 5a and 5b show the lift chart for a model built during model building and out of time testing stage.

### Block 210. Implementation of Logistic Mode:

Every month, the chassis (vehicles), which had come for service in 18 months prior to the observation date are scored based on the final logistic model. Twenty five months of history prior to the observation date is shared via databases, such as those from Teradata® (Data Warehousing, Data Analysis, and Big Data, of Dayton, Ohio, USA, www.teradata.com). This sales and service history is further used to calculate derived variables and score the chassis based on a final logistic equation. This provides the probability of churn for each chassis, based on which chassis is identifiable with a higher churn probability.

### Block 211. Selection of Actionable Variables:

To reduce the churn of chassis from service, action segments will be created. Action segments are designed to explain “why” a chassis is identified as a high churn risk. They are intended to be overlaid on the churn risk deciles to provide workshop managers with data on which to take specific actions for the respective chassis. The action segments were designed using the predictors that are “actionable”—were business can intervene and produce changes in the values of the predictor that are favorable for the chassis. If the predictor has high predictive power, but is not actionable, it will not be used/tested while creating action segments.

Table 7 presents an example of actionable versus non actionable variables.

After analysis on actionability, whether a predictor can be improved by business interventions, a plurality of actionable variables (i.e., 45 Variables) were created.

### Block 212. Multicollinearity Check on Actionable Variables:

Multicollinearity is a phenomenon in which two or more predictor variables in a multiple regression model are highly correlated, meaning that one can. be linearly predicted from the others with a non-trivial degree of accuracy.

Processes to tackle multicollinearity:

VIF (Variance Inflation Factor) measures how much the variance of the estimated regression coefficient “bk” is “inflated” by the existence of correlation among the predictor variables in the model, a cutoff of VIF<10, is used to tackle multicollinearity.

VIF(βᵢ)=1/(1−R²)

During a multicollinearity check, where VIF>10, eight variables were dropped in the process. Thus 37 variables (remaining from the 45 variables) were further considered for Action segment building via Chassis analysis.

Block 213. Action Segments Creation using Decision Tree:

Decision trees are produced by algorithms that identify various ways of splitting a dataset into branch-like segments. These segments form an inverted decision tree that originates with a root node at the top of the tree. The object of analysis is reflected in this root node. The discovery of the decision rule to form the branches or segments underneath the root node is based on a method that extracts the relationship between the object of analysis (target field in the data) and one or more fields that serve as input fields (actionable predictor variables) to create the branches or segments.

### Decision Tree Elements:

### Node:

Each segment or branch of a decision tree is called node. A node can be further descended inward, to form. additional branches or segments of that node.

### Leaves:

The bottom most nodes (which cannot/should not be further descended) are called terminal nodes or leaves, For each leaf, the decision rule provides a unique path for data to enter the leaf. All nodes, including the bottom leaf nodes, have mutually exclusive assignment rules; as a result, records or observations from the parent data set can be found in one node only.

Table 8 contains a list of rules followed during decision tree building.

### Decision Tree Output/Action Segments

Table 9a contains the final list of significant predictor variables that are part of action segments.

Seven actionable valiables were identified as significant to the customers coming to their network for their servicing needs. One or a combination of these 7 actionable variables were important to the customer as per the action segment (Table 9c) to which the customer belongs. Table 9b contains the list of significant actionable variables and the actions required against them for saving churn.

Table 9c highlights the 11 action segments deduced from the decision tree highlighting the combination of actionable variables that are important to the segment. The suggested actions need to be implemented on chassis as per their segments if their churn probability is high. Chassis failing in the top 30% bracket of churn probability are defined as the High Churn probability chassis.

### Block 214. Implementation Of Action Segments:

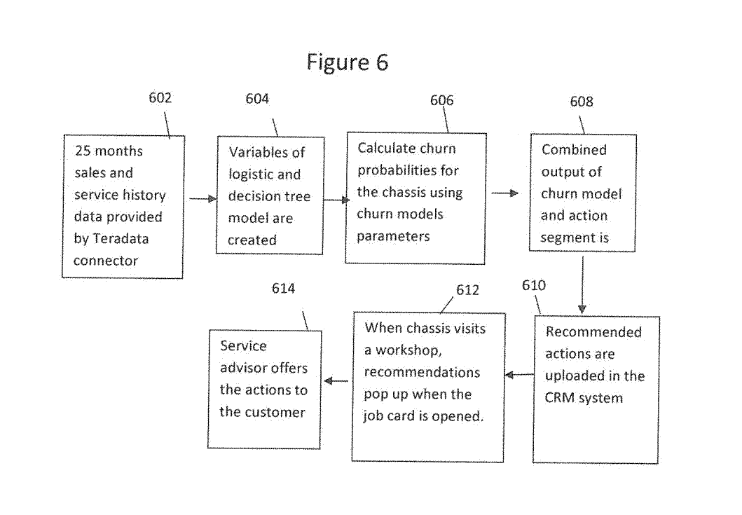

FIG. 6 shows a flow chart illustrating the complete process to be followed every month to implement the service churn model in which chassis with high probability of churn are highlighted and action segments to reduce the risk of churn are provided.

Initially, at block 602, twenty-five month sales and service data for each chassis (vehicle) is provided. The process moves to block 604, where variables of a Logistic and Decision Tree model are created. Next, at block 606, churn probabilities are calculated for each chassis (vehicle) using the churn model's performance. The process moves to block 608, where the combined output of the churn model and the activation segment are provided. The process moves to block 610, where recommended actions are uploaded in the CRM system. Next, at block 612, when a chassis (vehicle) visits a workshop (vehicle service center) recommendation pop up on screen when the job card for that vehicle is opened. The process concludes at block 614, where, either on-line or off line, a service advisor offers actions and recommendations to the customer, associated with the chassis (vehicle).

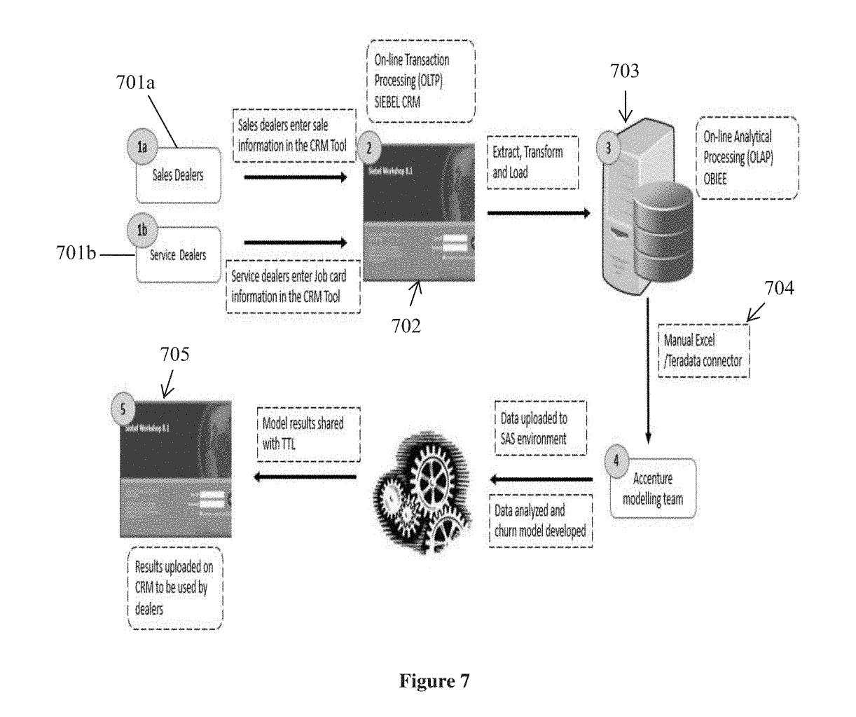

FIG. 7 shows the flow diagram illustrating flow of data from dealers to final output in detail. Various components and steps involves in the flow of data from dealers to final output is described below:

### Sales Dealers 701a:

Sales Dealers record information related to the chassis sold, such as Customer name and details, Chassis no etc. This is captured and stored in sales module of transactional system database Online Transactional Processing (OLTP).

### Service Dealers 701b:

Service Dealers record job card information when chassis come in for service, such as Chassis details, Job Card details, Service type, Invoice value etc. This is captured and stored in the service module of transactional system database (OLTP).

### OLTP 702:

Online transaction processing (OLTP) is the central repository for sales, service and spares databases. These databases include the transaction data from sales and service dealers.

### OLAP Server 703:

The OLTP data available from transaction side is moved via ETL (Extract, Transform and load) from transaction side for analyzing and becomes OLAP (Online Analytical Processing) data. This server 703 includes various processors, e.g., for building predictive models, such as those for determining the probability that a vehicle remains in the network, storage/memory for storing machine readable instructions for the processors, as well as modules, which also store machine readable instructions for execution by the processors, and engines, such as an SAS® Analytical Engine (SAS Institute Inc. of Cary, N.C., USA), housed in or otherwise associated with the server 703. Other applications of the processors and other data processing tools of the server 703 build regression models, and create variables for all of the models built by the processor and server 703. The processors also interact with the databases of the OLTP 702, as the OLAP 702 provides databases, such as a data warehouse. This server 703 links to one or more networks, including the Internet, cellular networks and other wide area and local networks and facilitates various online transactions, derailed herein. The data warehouse is a Relational/Multidimensional database that is designed for queries and analysis, rather than for transaction processing.

### Modeling Team 704:

Modeling team receives data via Excel® from Microsoft Corporation of Redmond Wash., USA/Teradata® connecter from OLAP. This data is further uploaded on SAS® environment (SAS Institute, Inc. of Cary, N.C., USA) for analysis and model development.

### CRM (Customer Relationship Manager) 705:

Final model results are uploaded via EIM (Enterprise Information Manager) to the CRM 705 for the use of dealers.

Advantageously, the present invention is significant in ensuring that the customers are satisfied through their service leading to their retention. The present invention first precisely identifies the needs of each chassis and suggests a customized service solution that is derived basis advanced analytics.

The solution focuses on creating an econometric model that enables identification of the chassis which are coming for service with high churn probability. It follows up the identification process with a large number of reasons of churn and complementing the reasons with the solutions that can be taken to mitigate the churn risk. It facilitates increasing customer satisfaction and retention on chassis that have been acted upon with suggested actions.

Therefore, the present invention endeavors to retain the after-sales customers by providing an efficient solution to each customer in minimum possible time. The present invention discloses an effective method to predict individual commercial vehicle's probability to churn from their network for its servicing needs and formulating customized churn prevention strategies for individual chassis.

The present solution lies is in the field of Commercial Vehicle Service Analytics. The solution is used to increase the retention of vehicles in their network for its servicing needs. Given that the after-sales experience significantly impacts the overall business, implementation of the model's recommendations will help in increasing customer retention through increased customer satisfaction by providing customized after-sales experience desired by the customer.

This model, through applied econometrics, calculates the probability of the vehicle to churn from manufacturers for its servicing needs. These probabilities passed all tests of robustness based of statistical fundamentals. Post the identification of vehicles which are likely to churn; the model suggests actionable strategies for their churn prevention. The strategies are derived by analyzing the empirical data with joint application of business and statistical knowledge.

Thus, it provides first mover advantage in the industry to enhance the after-sale's experience of customers by identifying the service aspects they value, by using analytics. This also discourages the unorganized churn strategies followed by channel partners, without yielding significant business impact.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing, platform for executing a plurality of instructions. Optionally, the data processor includes a volatile memory fix storing instructions and/or data and/or a non-volatile storage, for example, non-transitory storage media such as a magnetic hard-disk and/or removable media, computer modules and the like, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, fur clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for determining the probability of a vehicle remaining in a network comprising authorized dealers and authorized points of service, comprising:
building a predictive model, using a processor, to determine the probability that the vehicle remains in the network, including:
obtaining vehicle sales data, vehicle service transactions, and a churn value; and,
creating variables for the predictive model from the obtained vehicle sales data, vehicle service transactions, and a churn value; and,
inputting variables to the model for a vehicle, to determine the probability of the vehicle remaining in the network.

2. The method of claim 1, wherein the churn value includes a probability that a vehicle will not return to a network point of service after the instant service, for its next service.

3. The method of claim 1, additionally comprising: prior to inputting variables for a vehicle, testing the predictive model.

4. The method of claim 3, wherein the testing the predictive model includes applying a missing value treatment to the predictive model.

5. The method of claim 4, wherein the testing the predictive model additionally includes performing a multicolinearity check.

6. The method of claim 5, wherein the testing the predictive model additionally includes applying logistic regression to a set of variables input into the predictive model for significance.

7. The method of claim 6, wherein the testing the predictive model additionally includes validating the predictive model.

8. A computer usable non-transitory storage medium having a computer program embodied thereon for causing a suitable programmed system to determining the probability of a vehicle remaining in a network comprising authorized dealers and authorized points of service, by performing the following steps when such program is executed on the system, the steps comprising:
building a predictive model to determine the probability that the vehicle remains in the network, including:
obtaining vehicle sales data, vehicle service transactions, and a churn value; and,
creating variables for the predictive model from the obtained vehicle sales data, vehicle service transactions, and a churn value; and,
inputting variables to the model for a vehicle, to determine the probability of the vehicle remaining in the network.

9. The computer usable non-transitory storage medium of claim 8, wherein the churn value includes a probability that a vehicle will not return to a network point of service after the instant service, for its next service.

10. The computer usable non-transitory storage medium of claim 8, additionally comprising: prior to inputting variables for a vehicle, testing the predictive model.

11. The computer usable non-transitory storage medium of claim 10, wherein the testing the predictive model includes applying a missing value treatment to the predictive model.

12. The computer usable non-transitory storage medium of claim 11, wherein the testing the predictive model additionally includes performing a multicolinearity check.

13. The computer usable non-transitory storage medium of claim 12, wherein the testing the predictive model additionally includes applying logistic regression to a set of variables input into the predictive model for significance.

14. The computer usable non-transitory storage medium of claim 13, wherein the testing the predictive model additionally includes validating the predictive model.

15. A method for determining the probability of a vehicle remaining in a network, the network comprising authorized entities, comprising:
a. building a predictive model, using a processor, to determine the probability that the vehicle remains in the network;
b. creating variables for the predictive model from data comprising one or more of: obtained vehicle sales data, vehicle service transactions, and a churn value;
c. obtaining the churn probability for the vehicle with respect to an authorized entity; and,
d. inputting variables and the churn probability into the predictive model for a vehicle to determine the probability of the vehicle remaining in the network.

16. The method of claim 15, wherein the obtaining the churn probability for the vehicle with respect to an authorized entity includes building a regression model, using a processor, and determining the churn probability from the regression model.

17. The method of claim 16, wherein the determining the churn probability from the regression model includes scoring the vehicle by using an equation:
Pᵢ=αᵢ+βXᵢ
where, Pᵢ is the churn probability, α is the intercept term in the equation, β is the coefficient of the predictor variable Xᵢ.

18. The method of claim 17, wherein the authorized entities include at least one of dealers and authorized points of service.
